(19) United States
(12) Patent Application Publication
(10) Pub. No.: US 2020/0244839 A1
(43) Pub. Date: Jul. 30, 2020

(54) COLOR SEPARATION TABLE CREATING METHOD, PROGRAM, AND PRINTING DEVICE

(71) Applicant: KONICA MINOLTA, INC., Tokyo (JP)

(72) Inventor: Kenichirou HIRAMOTO, Tokyo (JP)

(73) Assignee: KONICA MINOLTA, INC., Tokyo (JP)

(21) Appl. No.: 16/735,781

(22) Filed: Jan. 7, 2020

(30) Foreign Application Priority Data
Jan. 25, 2019 (JP) 2019-011174

(51) Int. Cl. H04N 1/60; H04N 1/54

(52) U.S. Cl. CPC H04N 1/6058; H04N 1/54; H04N 1/6008

(57) ABSTRACT

A color separation table creating method includes: setting a grid point having a process color as a color component and creating a color separation table in which a color on each grid point is represented by a separation value of each color component when the color is approximated by a mixed color of the process color and a spot color; smoothing the separation value corresponding to each grid point of the color separation table; and changing the separation value corresponding to each grid point of the color separation table after smoothing such that color shift by the smoothing is corrected, wherein, at the changing, while fixing the separation value of partial color component out of the process color and spot color, the separation value of another color component is changed.

The entire disclosure of Japanese patent Application No. 2019-011174, filed on Jan. 25, 2019, is incorporated herein by reference in its entirety.

### BACKGROUND

### Technological Field

The present invention relates to a color separation table creating method of creating a color separation table for converting a signal value of a process color into a separation value of each color component when a color represented by the signal value is approximated by a mixed color of the process color and a spot color, a program, and a printing device using the color separation table.

### Description of the Related Art

In order to enable printing with an expanded color reproduction range of a printer with inkjet and electrophotographic color printers, there is a color separation technology for multicolor using a color material (toner and ink) of green, orange, and violet in addition to a normal process color of cyan (C), magenta (M), and yellow (Y) or C, M, Y, and K (black).

Usually, a spot color is used for printing a portion especially specified by a color name thereof or used for a high-saturation portion, but is not often used otherwise. However, head maintenance is necessary also for eliminating nozzle clogging and the like, and it is desirable that the use of each color including the spot color be equalized to some extent. A used amount of the color material such as ink including the spot color is directly related to a cost, so that it is desired that this may be reduced.

For example, JP 2013-64778 A proposes an image forming device which performs multi-color printing when it is determined that printing with multiple colors may reduce the cost of color materials than that with the process color. In this device, input image data is converted into data for image formation (CMYK or CMYKα (a is a spot color)) using a profile corresponding to a system determined by a separating system determiner. The profile for converting the input image data into CMYKα converts into a combination of colors with a color difference of a predetermined value or smaller and a minimum cost equivalent value.

If CMYK is converted into CMYKα based on an index to simply minimize the color material cost, a gradation appears to have a step, and as illustrated in FIG. 14, a certain contour appears in an image which should be smooth. For example, in a range where a color changes gradually, a phenomenon occurs that printing using CMYK color materials and printing using CMYKα color materials frequently switch and a gradation of each color changes drastically, and a certain contour appears in this part, so that an image quality is deteriorated.

### SUMMARY

The present invention is intended to solve the above-described problem, and an object thereof is to provide a creating method of a color conversion table for converting a signal value of a process color into a signal value approximated by a mixed color of the process color and a spot color without causing deterioration in image quality, a program, and a printing device using the color conversion table.

To achieve the abovementioned object, according to an aspect of the present invention, a color separation table creating method reflecting one aspect of the present invention comprises: setting a grid point having a process color as a color component and creating a color separation table in which a color on each grid point is represented by a separation value of each color component when the color is approximated by a mixed color of the process color and a spot color; smoothing the separation value corresponding to each grid point of the color separation table; and changing the separation value corresponding to each grid point of the color separation table after smoothing such that color shift by the smoothing is corrected, wherein, at the changing, while fixing the separation value of partial color component out of the process color and spot color, the separation value of another color component is changed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a flowchart illustrating an outline of a basic form of a color separation table creating method according to an embodiment of the present invention;

FIG. 2 is a flowchart illustrating a process of creating an initial color separation table (step S102 in FIG. 1) in detail;

FIG. 3 is a flowchart illustrating a process of correcting color shift while fixing a CMY value and changing a spot color value (step S104) in detail;

FIG. 4 is a flowchart illustrating an outline of a color separation table creating method in a first variation;

FIG. 5 is a flowchart illustrating a process of correcting color shift while fixing a spot color value and changing a CMY value (step S408 in FIG. 4) in detail;

FIG. 6 is a flowchart illustrating an outline of a color separation table creating method in a second variation;

FIG. 7 is a flowchart illustrating a process of removing a discontinuous point;

FIG. 8 is a view illustrating 4096 grid points corresponding to CMY values and a separation version of a CMYOVG separation value corresponding to each grid point (corresponding to an initial color separation table (first stage));

FIG. 9 is a view illustrating 4096 grid points corresponding to CMY values and a separation version of a CMYOVG separation value corresponding to each grid point (corresponding to a second stage obtained by removing a discontinuous point from the initial color separation table);

FIG. 10 is a view illustrating 4096 grid points corresponding to CMY values and a separation version of a CMYOVG separation value corresponding to each grid point (corresponding to a third stage obtained by performing a smoothing process on the second-stage color separation table);

FIG. 11 is a view illustrating 4096 grid points corresponding to CMY values and a separation version of a CMYOVG separation value corresponding to each grid point (corresponding to a fourth stage obtained by performing color shift correction on the third-stage color separation table);

FIGS. 12A to 12D are views respectively illustrating an example of a color chart printed by using the first to fourth-stage color separation tables;

FIG. 13 is a view illustrating an example of a schematic configuration of a printing device which uses the color separation table created by a method according to an embodiment of the present invention; and

FIG. 14 is a view illustrating an example in which a certain contour appears in an image which should be smooth in a case where spot color separation is performed simply using color material reduction as an index.

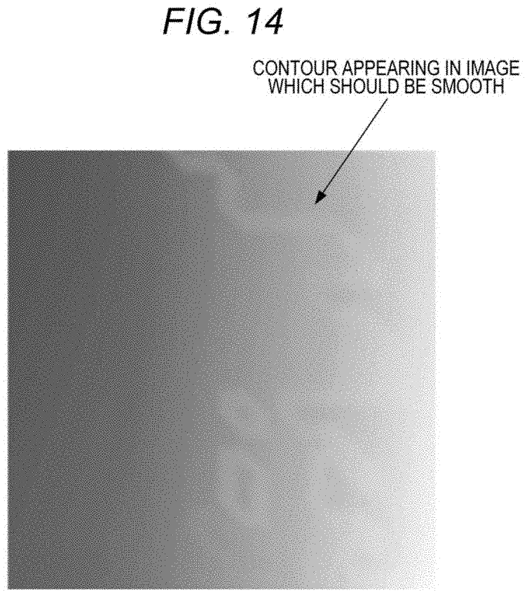

### DETAILED DESCRIPTION OF EMBODIMENTS

Hereinafter, one or more embodiments of the present invention will be described with reference to the drawings. However, the scope of the invention is not limited to the disclosed embodiments.

The present invention relates to a creating method of a color separation table for converting an input signal value (CMY value or CMYK value) represented by a process color (cyan (C), magenta (M), and yellow (Y), or C, M, Y, and black (K) into a separation value of each color component (spot color separation value) when the same color as a color represented by the input signal value is approximated by a mixed color of the process color and a spot color, a program for implementing the creating method by an information processing device, and a printing device which uses the created color separation table.

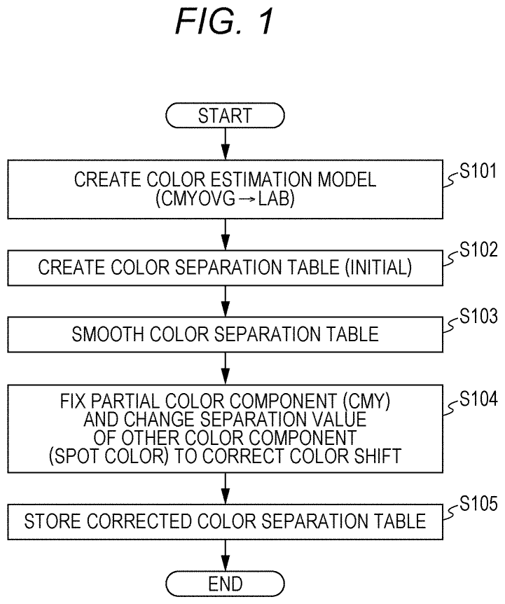

FIG. 1 is a flowchart illustrating an outline of a color separation table creating method (basic form). In the following, green (g), violet (v), and orange (o) are used as the spot colors. The spot colors are not necessarily limited by these colors and the number of colors. The number of spot colors may be arbitrary, such as one, two, or four.

<Color Estimation Model Creation: Step S101>

A color estimation model is created by printing a chart for profile creation and performing colorimetry thereon using a predetermined ink amount limiting method. That is, ink amount limitation inherent to a printer is performed on an input value of CMYKOVG to obtain CMYKOVG′, printing is performed according to this signal value, and a LAB value is obtained by performing colorimetry on a printed matter for various input values, so that the color estimation model (profile) indicating a correspondence relationship between the input value (CMYKOVG) and the LAB value is created.

The color estimation model may be created independently as described above, or may be created by using a signal value-LAB characteristic of an ICC profile.

<Initial Color Separation Table Creation: Step S102>

The color separation table is created based on the color estimation model. The spot color separation value of a color which coincides with a color corresponding to the CMY(K) value defined at each multi-dimensional grid point is set (step 1). Herein, the CMY value is converted into the LAB value, and the CMYOVG value having the same LAB value as this LAB value is obtained by using the color estimation model, so that the color separation table (six-color separation LUT) for converting the CMY value into the CMYOVG value is created, and K is used as it is. Note that, a similar method may also be used with the color separation table (CMYK→4to7LUT (multi-dimensional grid point)→CMYKOVG) to which the CMYK value is input and from which the CMYKOVG values is output.

A creation example of a specific color separation table is described. For example, 16 representative values are selected for each of C, M, and Y, and 16×16×16=4096 three-dimensional grid points are obtained. Herein, by using reduction in ink amount (color material amount) as an index, the spot color separation value of a combination with the minimum ink amount, the same color as the color represented by the CMY value of each grid point (with the minimum value converted from the separation value into a total ink amount) is obtained. Note that, in a case where the ink amount is not reduced (or in a case of a color which cannot be represented only by CMY such as each of CMY pure colors), the original CMY value is used as the spot color separation value as it is.

For example, the combination of minimum ink is searched for regarding each combination of the following group a).

Group a) gmc, gmy, mco, yco, ymv, and ycv

These are combinations of one spot color and two colors out of CMY other than the color with hue the closest to that of the spot color (the combination of two colors close to the spot color out of CMY as seen in a hue circle is avoided). By combining these three colors, a wide color gamut is secured. The combination of the three colors is intended to reduce the ink amount as compared with that with the three colors of CMY.

Note that, it is also possible to search a group a)+b) obtained by adding the following group b).

Group b) ovc, ovy, gym, gvy, gom, and goc

These are combinations of two spot colors and one of CMY other than the color between those spot colors.

In this manner, the spot color separation value of the combination having the minimum ink amount is temporarily determined for each grid point (CMY value of the grid point). Note that, for simplicity, K color is not combined and is not converted to be passed over, but the K color may also be combined.

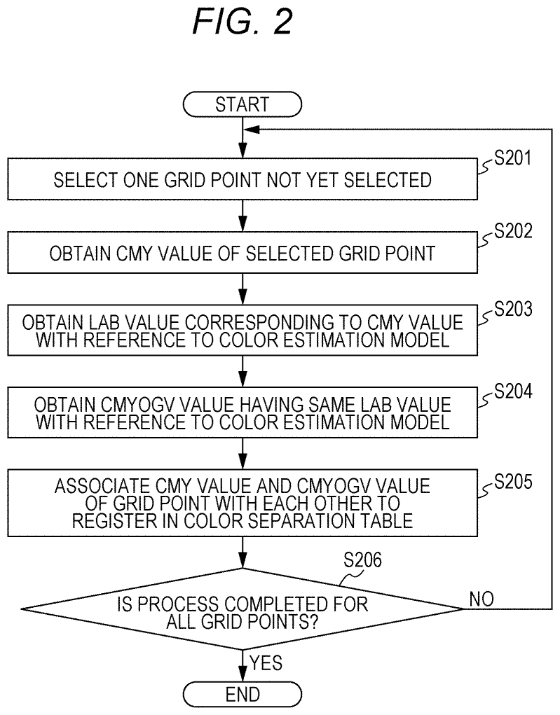

FIG. 2 is a flowchart illustrating a process of creating an initial color separation table (step S102 in FIG. 1) in detail. Out of the grid points having CMY as the color components, one grid point not yet selected is selected (step S201). The CMY value of the selected grid point is obtained (step S202), and the LAB value corresponding to the CMY value is obtained with reference to the color estimation model (step S203).

Next, the color estimation model (in this example, the group a) or group a)+b) is searched for the CMYOVG value having the same LAB value as this LAB value (the CMYOVG value having substantially the same color) to obtain the same (step S204) and the CMY value selected at step S202 and the CMYOVG value obtained at step S204 are associated with each other to be registered in the color separation table (step S205).

The above-described process is repeated until this is executed for all the grid points (step S206; No), and when the process is completed for all the grid points (step S206; Yes), the creating process of the initial color separation table is completed (end).

Next, a correcting process of the initial color separation table is performed. The correction of the color separation table is configured based on a smoothing process and a color shift correcting process of correcting color shift caused by the smoothing.

<Smoothing of Color Separation Table: Step S103>

The color separation table is smoothed for each color component of the spot color separation value. The smoothing between adjacent grid points may be performed by a known method. For example, the smoothing is performed by a moving average between adjacent grid points with respect to three axes for a CMY grid and four axes for a CMYK grid, a product-sum filter or the like. As a result, a step in switching between a color gamut printed by CMY and a color gamut printed by spot color separation such as the group a) may be reduced and smoothed. Note that, the color separation table before the smoothing is left, and the color separation table after the smoothing is created separately. The smoothing is performed for the grid points other than an end point.

<Color Shift Correcting Process: Step S104>

When the smoothing process is performed on the initial color separation table, the color shift occurs as trade-off of the smoothing, so that it is corrected such that the color shift is reduced. This correction is to change the other value while fixing one of the process color (CMY or CMYK) and the spot color such that the color shift is eliminated. Herein, the CMY value is fixed and the spot color value is corrected. In this manner, by fixing the separation value on one side (CMY side), it is possible to correct the color shift by changing the value of the other (spot color) while maintaining smoothness. Note that, if it is corrected arbitrarily without setting a fixed value, it returns to the value before the smoothing, so that a partial color component value is fixed.

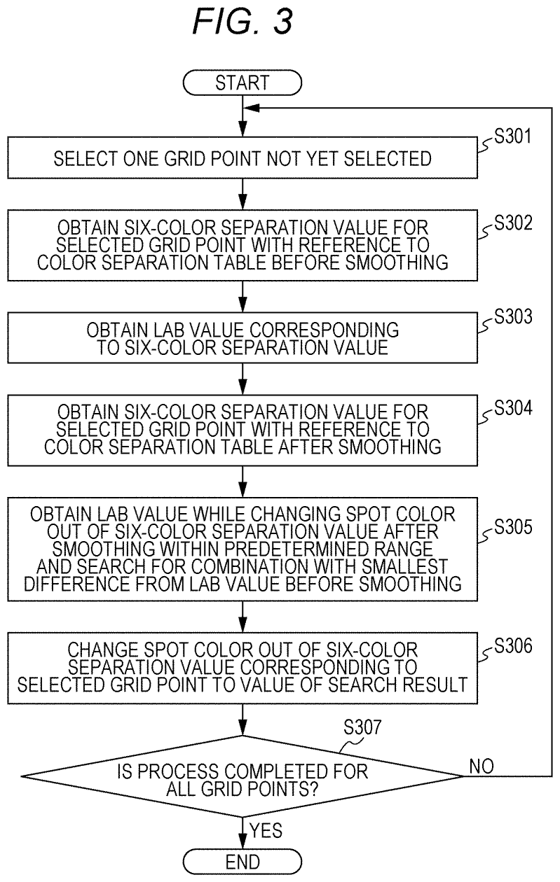

FIG. 3 is a flowchart illustrating a process of correcting the color shift while fixing the CMY value and changing the spot color value (step S104 in FIG. 1) in detail. Any one grid point not yet selected out of the CMY grid points is selected (step S301), and a six-color separation value (CMYOVG value) for the selected grid point is obtained with reference to the color separation table before the smoothing (step S302). Then, the LAB value corresponding to the six-color separation value is obtained with reference to the color estimation model and the like (step S303).

Next, the six-color separation value (CMYOVG value) for the grid point selected at step S301 is obtained with reference to the color separation table after the smoothing (step S304). Out of the six-color separation value after the smoothing, the CMY value is fixed and the spot color value is changed within a predetermined range to obtain the corresponding LAB value, and the spot color value with which a difference from the LAB value before the smoothing is minimum is searched for (step S305). Since the predetermined range in which the spot color value is changed is limited even in a case where there are two or more spot colors to be changed, the number of combinations is limited, and a processing burden associated with the search is small. Note that, in a case where all the spot color values are 0, no change is made.

When a search result is obtained, the spot color value of the six-color separation value corresponding to the grid point selected at step S301 is changed to the spot color value of the search result (step S306). The above-described process is repeatedly performed until this is executed for all the CMY grid points (step S307; No), and when the process is completed for all the CMY grid points (step S307; Yes), the color shift correcting process is finished (end). Herein, separately from the color separation table before the correction, the corrected one is created as a new color separation table.

Next, a variation realized by partly changing the basic form of the color separation table creating method is described.

<First Variation>

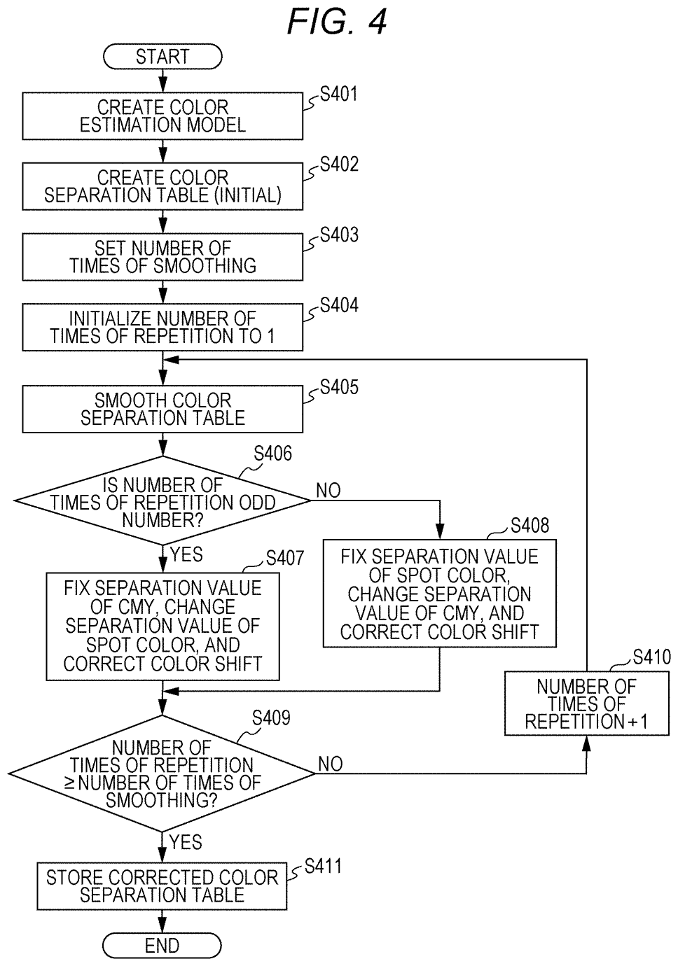

FIG. 4 is a flowchart illustrating an outline of a color separation table creating method in a first variation. As in the basic form illustrated in FIG. 1, green (g), violet (v), and orange (o) are used as spot colors.

In the first variation, smoothing and a color shift correcting process of the color separation table are made one set, and this is repeatedly performed a predetermined number of times. For each color shift correcting process, out of the CMY value and the spot color value, that the value of which is fixed and that the value of which is changed are switched.

In FIG. 4, first, in a manner similar to that of the basic form illustrated in FIG. 1, a color estimation model is created (step S401), and an initial color separation table is created (step S402). Next, the number of times of smoothing is set to an arbitrary value (step S403), and the number of times of repetition (counter) is initialized to 1 (step S404).

Thereafter, the initial color separation table is smoothed in a manner similar to that at step S103 in FIG. 1 (step S405), and if the number of times of repetition is an odd number (step S406; Yes), the CMY value out of a six-color separation value is fixed, the spot color value is changed, and the color shift is corrected as in a manner similar to that at step S104 in FIG. 1 for all the CMY grid points of the color separation table smoothed at step S405 (step S407). Thereafter, the procedure shifts to step S409.

On the other hand, if the number of times of repetition is an even number (step S406; No), the spot color value out of the six-color separation value is fixed, the CMY value is changed, and the color shift is corrected for all the CMY grid points (step S408), and the procedure shifts to step S409.

At step S409, it is determined whether the number of times of repetition reaches the number of times of smoothing set at step S403, and in a case where this does not reach (step S409; No), the number of times of repetition is incremented by 1 (step S410), and the procedure returns to S405 to be continued. Note that, at second and subsequent step S405, the smoothing process is performed on the latest color separation table which is already smoothed and the color shift of which is corrected.

When the number of times of repetition reaches the number of times of smoothing (step S409; Yes), the color separation table after the correction is stored (step S411), and the procedure is finished.

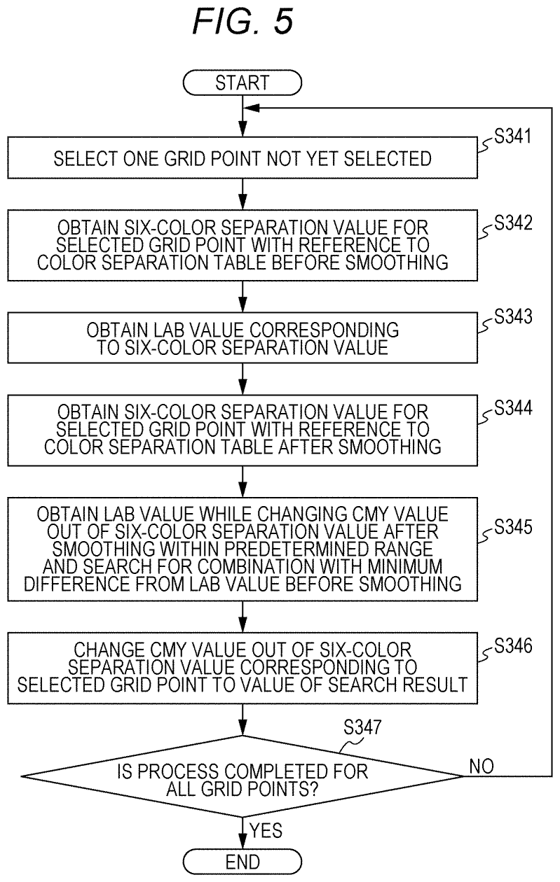

FIG. 5 is a flowchart illustrating the process of correcting the color shift while fixing the spot color value and changing the CMY value (step S408 in FIG. 4) in detail. Any one grid point not yet selected out of the CMY grid points is selected (step S341), and the six-color separation value (CMYOVG value) for the selected grid point is obtained with reference to the color separation table before the smoothing (step S342). Then, the LAB value corresponding to the six-color separation value is obtained with reference to the color estimation model and the like (step S343).

Next, the six-color separation value for the grid point selected at step S341 is obtained with reference to the color separation table after the previous smoothing process (step S344). Out of the six-color separation value after the smoothing, the CMY value is changed within a predetermined range while the spot color value is fixed to obtain the corresponding LAB value, and the CMY value with which a difference from the LAB value before the smoothing is minimum is searched for (step S345). In a case where all the spot color values are 0, no change is made.

When a search result is obtained, the CMY value out of the six-color separation value corresponding to the grid point selected at step S341 is changed to the CMY value of the search result (step S346). The above-described process is repeatedly performed until this is executed for all the CMY grid points (step S347; No), and when the process is completed for all the CMY grid points (step S347; Yes), the color shift correcting process is finished (end). Note that, separately from the color separation table before the correction, the corrected one is created as a new color separation table.

<Second Variation>

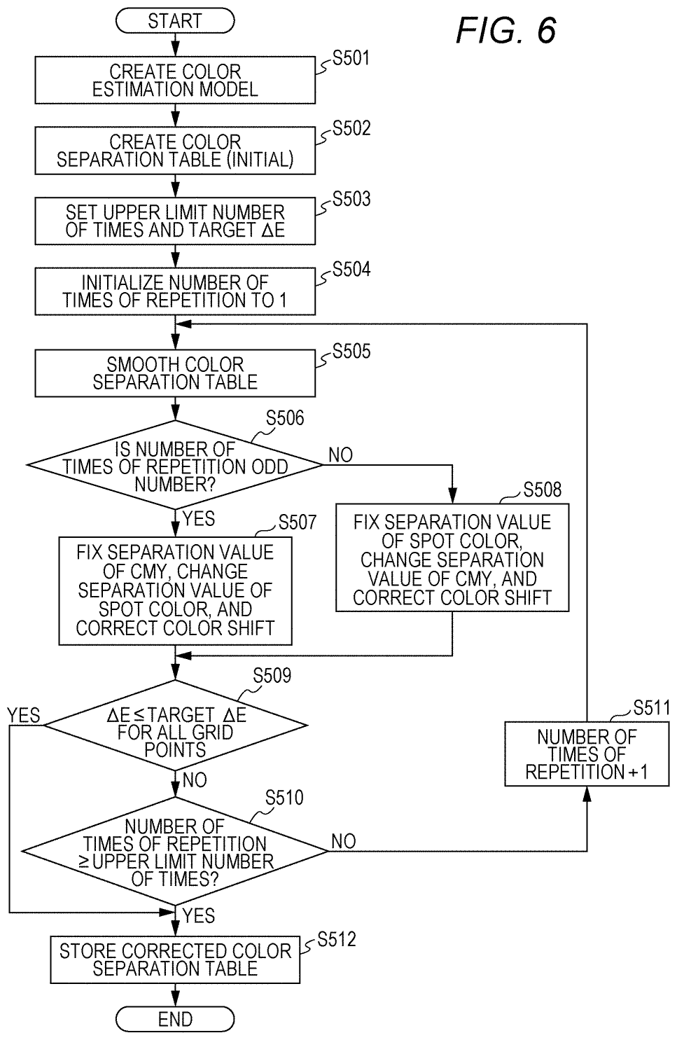

FIG. 6 is a flowchart illustrating an outline of a color separation table creating method in a second variation. As in the basic form illustrated in FIG. 1, green (g), violet (v), and orange (o) are used as spot colors.

In the second variation, smoothing and a color shift correcting process of a color separation table are repeatedly performed until a color difference (ΔE) from a color represented by a spot color separation value of an initial color separation table falls within a predetermined value or smaller or the number of times of repetition reaches a predetermined value at all grid points. An allowable range of color shift is increased, and when this falls within a color difference of about 3, for example, it is considered to be excellent. As in the first variation, for each color shift correcting process, out of a CMY value and a spot color value, that the value of which is fixed and that the value of which is changed are switched.

In FIG. 6, first, in a manner similar to that of the basic form illustrated in FIG. 1, a color estimation model is created (step S501), and an initial color separation table is created (step S502). Next, an upper limit number of times of smoothing process is set to an arbitrary plural number, and a target color difference ΔE is set (step S503). Furthermore, the number of times of repetition (counter) is initialized to 1 (step S504).

Thereafter, the initial color separation table is smoothed in a manner similar to that at step S103 in FIG. 1 (step S505), and if the number of times of repetition is an odd number (step S506; Yes), the CMY value out of a six-color separation value is fixed, the spot color value is changed, and the color shift is corrected as in a manner similar to that at step S104 in FIG. 1 for all the CMY grid points of the color separation table smoothed at step S505 (step S507). Thereafter, the procedure shifts to step S509.

On the other hand, if the number of times of repetition is an odd number (step S506; No), the spot color value of the six-color separation value is fixed, the CMY value is changed, and the color shift is corrected for all the grid points as at step S408 in FIG. 4 (step S508), and the procedure shifts to step S509.

At step S509, it is determined whether the color difference from the color represented by the six-color separation value in the initial color separation table is within the target color difference ΔE for all grid points, and if a determination result is true (step S509; Yes), the color separation table after the correction is stored (step S512), and the procedure is finished.

If the determination result is false (step S509; No), it is determined whether the number of times of repetition reaches the upper limit number of times of smoothing (step S510), and in a case where this does not reach (step S510; No), the number of times of repetition is incremented by 1 (step S511), and the procedure returns to S505 to be continued. Note that, at second and subsequent step S505, the smoothing process is performed on the latest color separation table which is already smoothed and the color shift of which is corrected.

When the number of times of repetition reaches the upper limit number of times of smoothing (step S510; Yes), the color separation table after the correction is stored (step S512), and the procedure is finished.

<Third Variation>

In a third variation, after an initial color separation table is created, a process of removing a discontinuous point is performed before this is smoothed. When searching for a combination of CMYOVG value having the same LAB value at step S204 in FIG. 2, if there is a plurality of combinations with almost balanced ink amounts and a combination with a slightly smaller ink amount is selected at each grid point, there is a case in which a grid point with different combination of colors from surrounding grid points appears in isolation and is discontinuous with the surroundings. For example, while surrounding grid points have a combination of yoc as a separation value, the grid point having a combination of ymv as a separation value appears in isolation. Therefore, a smoothing process may be effectively performed by eliminating such discontinuity before smoothing.

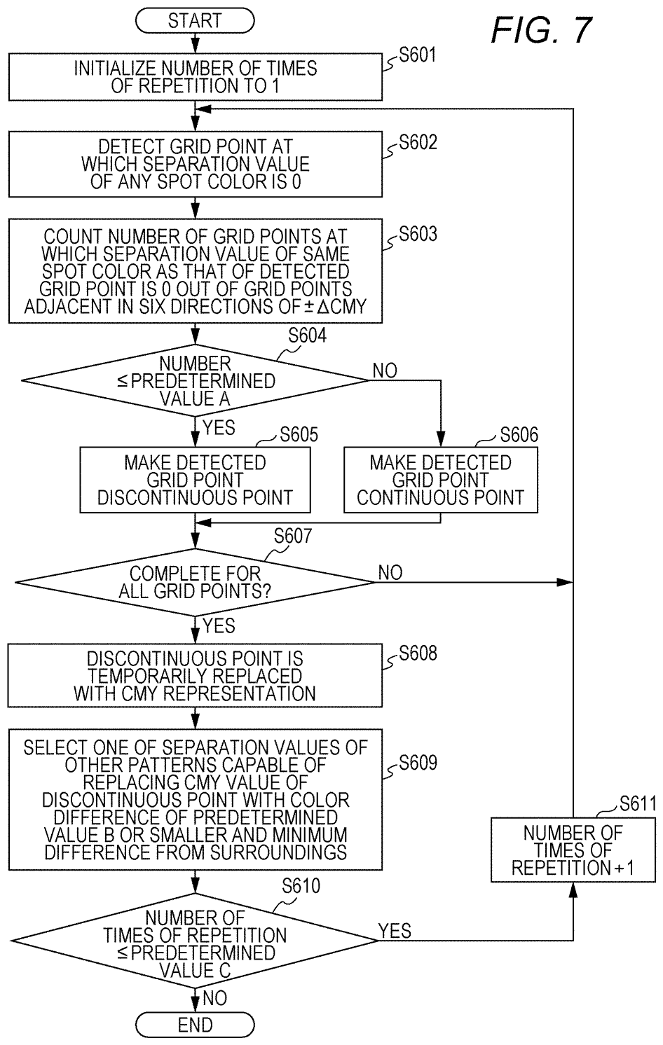

FIG. 7 is a flowchart illustrating a process of removing the discontinuous point. This process is performed between S102 and S103 in FIG. 1, after step S402 and before executing S405 for the first time in FIG. 4, and after step S502 and before executing S505 for the first time in FIG. 6.

First, the number of times of repetition is initialized to 1 (step S601), and in the initial color separation table, a grid point at which a separation value of any spot color is 0 is detected (step S602). Next, out of six grid points adjacent in each of positive and negative directions of C, M, and Y around the detected grid point, the number of grid points at which the separation value of the same spot color as that of the grid point at the center is 0 is counted. (step S603).

If a count value is equal to or smaller than a predetermined value A determined in advance (for example, 1) (step S604; Yes), the detected grid point is registered as the discontinuous point (step S605), and the procedure shifts to step S607.

On the other hand, in a case where the count value exceeds the predetermined value A (step S604; No), the detected grid point is registered as a continuous point (step S606), and the procedure shifts to step S607.

At step S607, it is checked whether determination of continuity/discontinuity is finished for all the grid points, and if there is the grid point not yet determined (step S607; No), the procedure returns to step S602 to be continued.

If the determination is finished for all the grid points (step S607; Yes), the spot color separation value of the discontinuous point is temporarily replaced to return to a CMY value of that grid point (step S608). Next, out of the spot color separation values of other patterns (for example, six patterns in group a)) capable of replacing the CMY value of the discontinuous point such that the LAB value is the same, the one with a color difference of a predetermined value B (for example, 3.5) or smaller and with a minimum difference from the spot color separation value of the surrounding grid points (difference as a signal value) is selected as the spot color separation value of the grid point to replace (step S609).

If the number of times of repetition of the above-described process is equal to or smaller than a predetermined value C (for example, 0 to 5) (step S601; Yes), the number of times of repetition is incremented by 1 (step S611) and the procedure returns to step S602, and it is determined whether the grid point is the discontinuous point anew for all the grid points (steps S602 to S607). If the number of times of repetition is not equal to or smaller than the predetermined value C (step S610; No), this procedure ends.

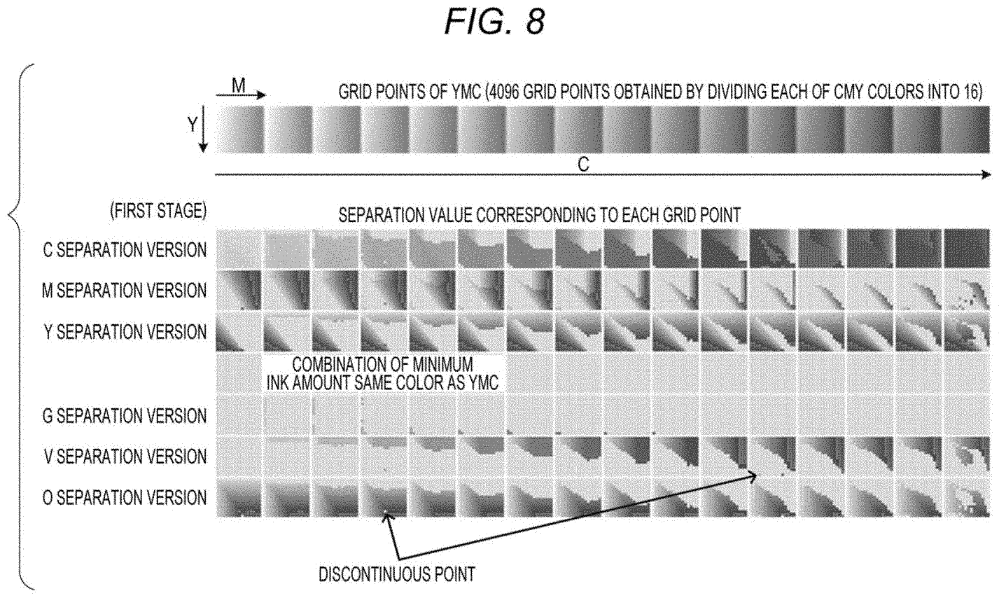

FIG. 8 corresponds to the initial color separation table (first stage), and illustrates each CMY grid point (each input value of the color separation table) and a separation version of the separation value of CMYOVG (spot color separation value which becomes an output value of the color separation table). Herein, 16 representative values are defined for each component of CMY, 16×16×16=4096 grid points are set, and the separation version of the spot color separation value corresponding to each grid point is illustrated.

In the initial color separation table, the spot color separation value with which the ink amount is the minimum is obtained for each grid point, so that the discontinuous point appears.

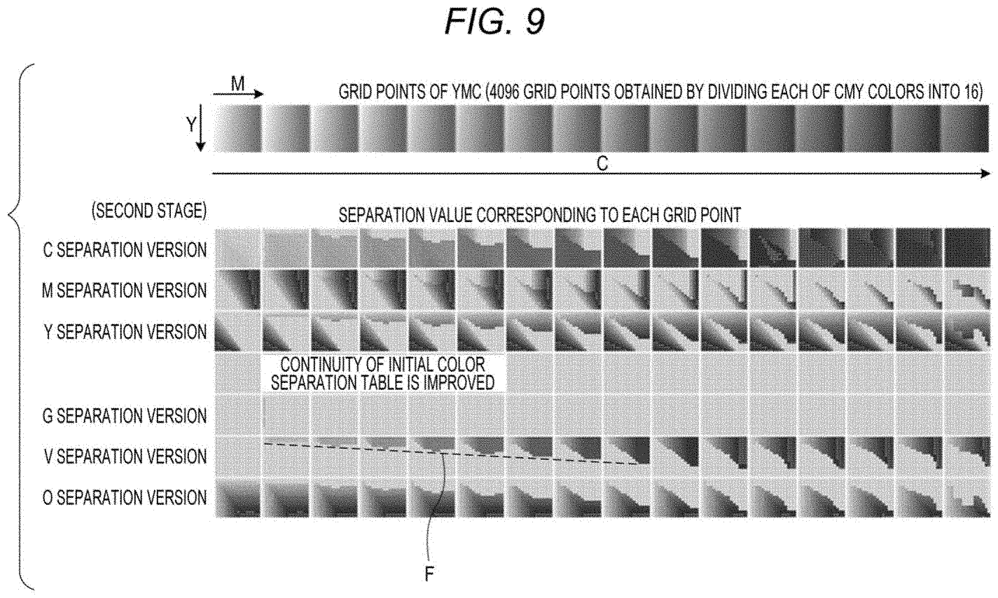

FIG. 9 illustrates a color separation version corresponding to a second-stage color separation table obtained by performing a process of removing the discontinuous point on the initial color separation table. The discontinuous point in FIG. 8 is removed, and continuity is improved. However, in each color component, a value drastically changes between a part with color and a part without color (refer to a portion indicated by broken line F and the like in the drawing).

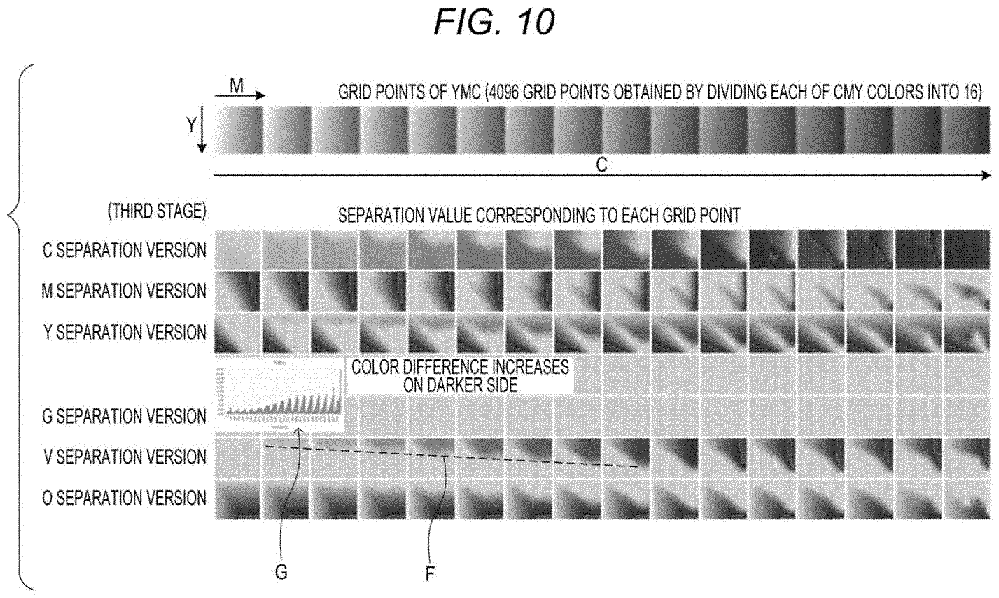

FIG. 10 illustrates a color separation version corresponding to a third-stage color separation table obtained by performing a smoothing process on the second-stage color separation table. For example, comparing the portion of broken line F with that in FIG. 9, it is understood that the smoothness is improved. However, by improving the smoothness, color shift occurs with respect to the color separation table before the smoothing. A color shift amount increases on a dark color side. A graph G in the drawing illustrates the color shift amount from the color represented by an original CMY value for each grid point.

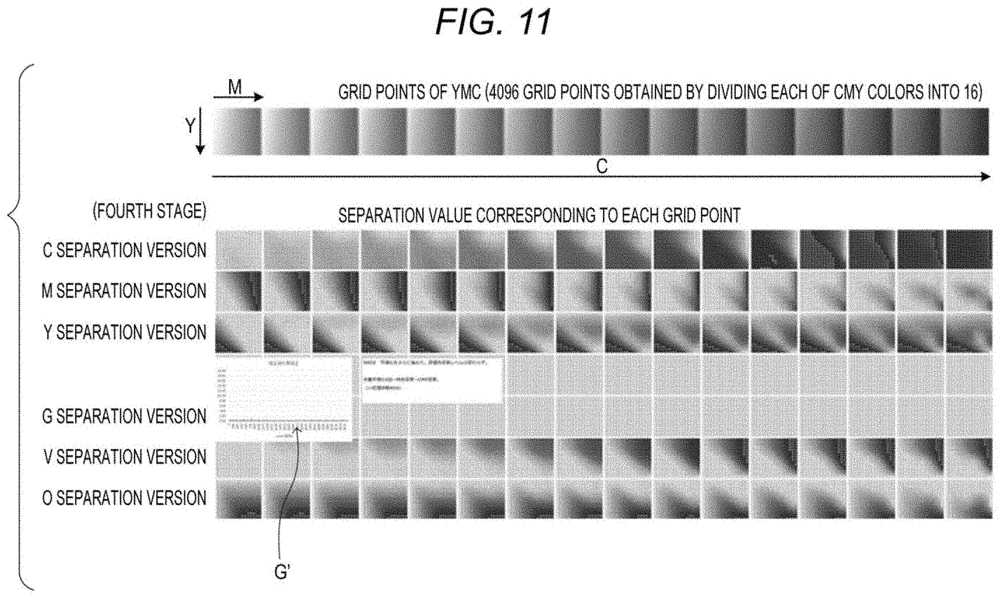

FIG. 11 illustrates a color separation version corresponding to a fourth-stage (final result) color separation table obtained by performing color shift correction on the third-stage color separation table. In this example, the color shift is corrected while fixing the CMY value and changing the spot color value. A graph G′ in the drawing illustrates the color shift amount from the color represented by the original CMY value for each grid point after the color shift is corrected. It is understood that the color shift is improved while the smoothness is maintained.

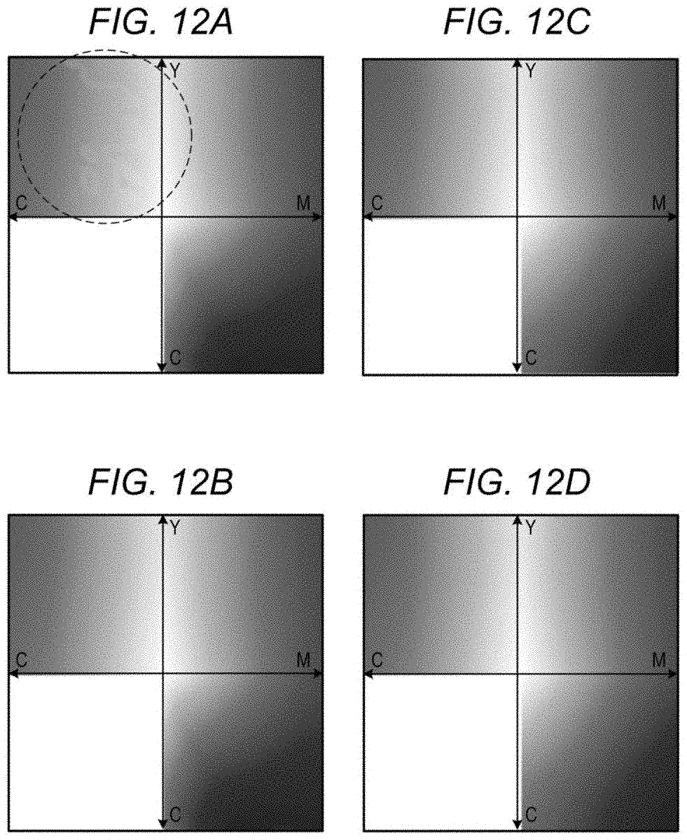

FIGS. 12A to 12D respectively illustrate a color chart printed by using the first to fourth-stage color separation tables. When it is printed after the CMY value is converted into the spot color separation value (CMYOVG value) in the first-stage (simple combination) color separation table, a certain contour appears in the image which should be smooth as illustrated in FIG. 12A. FIG. 12B illustrates that printed by using the second-stage (improve in continuity) color separation table, FIG. 12C illustrates that printed by using the third-stage (improve in smoothness) color separation table, and FIG. 12D illustrates that printed by using the fourth-stage (after color correction) color separation table.

Note that the color separation table is created by the method described heretofore, for example, by a printer manufacturer's computer or by a printer driver program installed in a user's personal computer. The color separation table created by the manufacturer is stored in advance in the printer or stored in a server of the manufacturer, and is downloaded to be distributed from the server to the printer. The color separation table created by the driver program is transmitted from the printer driver to the printer to be used by the printer.

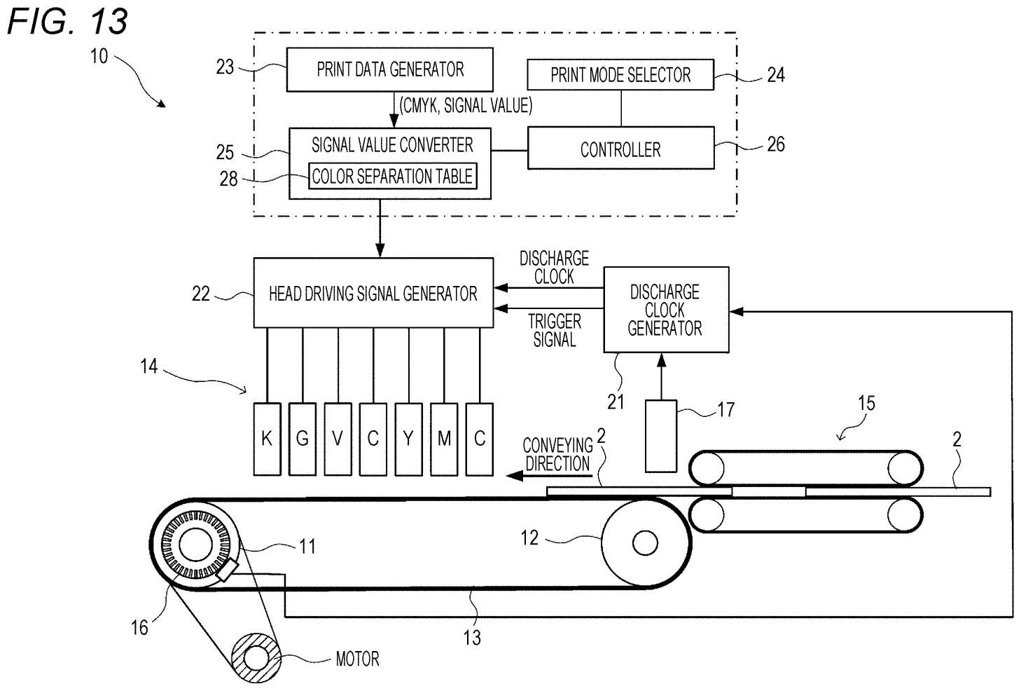

FIG. 13 illustrates an example of a schematic configuration of a printing device 10 which uses the color separation table created by the method according to the present invention. The printing device 10 is an inkjet printer which discharges ink droplets from a recording head to record an image on a sheet-shaped recording medium 2 such as paper, cloth, and film.

The printing device 10 includes a conveyor which circulate a conveyor belt 13 stretched so as to surround a driving shaft 11 and a driven shaft 12 to convey the recording medium 2, and a recording head unit 14 as an image former which discharge ink to the recording medium 2 conveyed by the conveyor belt 13 to form an image. The recording head units 14 of respective colors are arranged along the conveyor belt 13 in the order of CMYOVGK from an upstream side to a downstream side in a conveying direction in which the conveyor belt 13 conveys the recording medium 2. The conveyor further includes a paper feeder mechanism 15 which feeds the recording medium 2 from a paper feeder tray not illustrated to convey and delivers the same to the conveyor belt 13.

The driving shaft 11 around which the conveyor belt 13 is stretched rotates with rotation of a motor transmitted thereto through a transmission belt. A rotary encoder 16 is attached to the driving shaft 11. The rotary encoder 16 outputs a reference pulse (Z-phase signal) every time the driving shaft 11 makes one revolution, and outputs a large number of (for example, 4096) pulses (A-phase signals) while the driving shaft 11 makes one revolution at equiangular intervals.

In the vicinity of an upstream end of the conveyor belt 13, a medium passage sensor 17 is provided for detecting the recording medium 2 delivered from the paper feeder mechanism 15 to pass through the portion.

The printing device 10 is further provided with a discharge clock generator 21, a head driving signal generator 22, a print data generator 23, a print mode selector 24, a signal value converter 25, a controller 26 and the like. The print data generator 23, the print mode selector 24, the signal value converter 25, and the controller 26 are configured with a central processing unit (CPU), a read only memory (ROM), a random access memory (RAM) and the like as substantial parts, and when the CPU executes various processes according to the program stored in the ROM, the functions are realized.

The discharge clock generator 21 inputs the A-phase and Z-phase pulses output from the rotary encoder 16 and an output signal of the medium passage sensor 17, and generates, based on them, a trigger signal indicating a print start timing and a discharge clock signal serving as a reference of a print timing of each line to output to the head driving signal generator 22.

The head driving signal generator 22 outputs a driving signal a timing of which is controlled based on the trigger signal and the discharge clock signal to the recording head unit 14.

The print mode selector 24 receives selection between a basic mode in which the image is formed only with a process color, and a spot color using mode in which the process color and a spot color (in this example, C, M, Y, K, O, V, and G) are used to form the image. This selection is received, for example, from the user through an operation panel not illustrated provided on the printing device 10 or received by mode specifying information included in a print job received from an external device.

In a case where the basic mode is selected by the print mode selector 24, the controller 26 controls to form the image using only the process color on the recording medium 2, and in a case where the spot color using mode is selected by the print mode selector 24, this instructs the signal value converter 25 to convert the signal value of the process color input from the print data generator 23 into the spot color separation value to output to the head driving signal generator 22, thereby controlling to form the image by using the process color and the spot color on the recording medium 2.

The print data generator 23 performs a RIP process or the like based on the print job received from the external device, generates the image data corresponding to the image to be printed in a form of CMYK value, and outputs the same to the signal value converter 25.

The signal value converter 25 holds a color separation table 28 created by the method according to the present invention. In a case where the signal value converter 25 receives an instruction to form the image in the basic mode from the controller 26, this applies ink amount limitation and the like using a normal profile on the CMYK value input from the print data generator 23 and outputs the same in a form of the CMYK value. In this case, an OVG value out of the signal output to the head driving signal generator 22 is set to 0.

On the other hand, in a case where the signal value converter 25 receives an instruction to form the image in the spot color using mode from the controller 26, this converts the CMYK value input from the print data generator 23 into the spot color separation value (CMYKOVG value) based on the color separation table 28 to output. Note that the signal value converter 25 derives the CMYK value and CMYKOVG value corresponding to a color between the grid points registered in the profile and the color separation table 28 by an interpolating process.

The head driving signal generator 22 generates a head driving signal according to the image data of the CMYK value or the spot color separation value input from the signal value converter 25, and outputs the same to the recording head unit 14 of the corresponding color. In a case of the basic mode, the CMYK recording head units 14 are driven according to the image data of the CMYK value, and the image is formed using only the process color. In the spot color using mode, the CMYKOVG recording head units 14 are driven according to the image data of the spot color separation value (CMYKOVG value), and the image is formed using the process color and spot color.

Note that, after CMYK conversion using the profile printed only with CMYK (CMY′K), this may be further separated into CMYK+spot color using the color separation table of the present invention (CMY′ component is replaced with CMYOVG′ to obtain CMYOVG′K), and the printing may be performed. By switching between this printing and printing using a CMY′K value converted using a profile printed only with CMYK, the ink amount may be switched while maintaining the same color reproduction. Note that the color separation table of the present invention may also be applied to a configuration (CMYK-CMYKOVG) in which a printer having a spot color is always used as a spot color printer. The conversion to the spot color separation value may be used for extending the color gamut.

As described above, according to the present invention, it is possible to convert the process color signal value into the signal value using the process color and the spot color (spot color separation value) while ensuring color consistency (substantially consistent also for the color gamut) and the smoothness of gradation. In addition, the smoothing process may be performed more effectively by adding the processing of eliminating the discontinuous point, and the spot color separation value which provides a better image quality may be obtained.

Note that, by using the color separation table of the present invention, it is possible to reduce the ink amount by 10% to 20% in a natural image sample.

Although embodiments of the present invention have been described and illustrated in detail, the disclosed embodiments are made for purposes of illustration and example only and not limitation. The scope of the present invention should be interpreted by terms of the appended claims. If there are changes and additions within the scope of the present invention, they are also included in the present invention.

The configuration of the printing device 10 described in the embodiment is an example and is not limited thereto. For example, although FIG. 13 illustrates a type in which the recording medium 2 is conveyed by the conveyor belt 13, an ink jet printer of a type in which the recording medium 2 is conveyed while being adhered to a conveyor drum may also be used. The present invention is not limited to the ink jet system, and may be applied to the printing device of an arbitrary system such as an electrophotographic printing device using toner as the color material.

The types and number of spot colors are not limited to those exemplified in the embodiment. In this embodiment, the initial color separation table is created using the ink amount reduction as the index, and the smoothing and the color shift correction (preferably, discontinuous point removal in addition) are applied thereto to obtain the final color separation table; however, the index when creating the initial color separation table is not limited to the ink amount reduction and may be arbitrary. For example, the initial color separation table may be created using “minimizing graininess” as the index.

At the time of color shift correction, in this embodiment, either the CMY value or the spot color is fixed and the other is changed, however, a method of selecting a part when fixing the part and the number of colors may be appropriately set; for example, two colors of YM are fixed and remaining four colors are changed to correct the color shift.

What is claimed is:

1. A color separation table creating method comprising:
setting a grid point having a process color as a color component and creating a color separation table in which a color on each grid point is represented by a separation value of each color component when the color is approximated by a mixed color of the process color and a spot color;
smoothing the separation value corresponding to each grid point of the color separation table; and
changing the separation value corresponding to each grid point of the color separation table after smoothing such that color shift by the smoothing is corrected,
wherein, at the changing, while fixing the separation value of partial color component out of the process color and spot color, the separation value of another color component is changed.

2. The color separation table creating method according to claim 1,
wherein, at the setting and creating, a color component value of the process color at each grid point is obtained, a color obtained by mixing process colors according to the color component value is made a color of the grid point, and a separation value when a color substantially the same as the color of each grid point is obtained by mixing the process color and the spot color is made the separation value corresponding to the grid point to create the color separation table.

3. The color separation table creating method according to claim 1,
wherein, in a case where a difference between the separation value of one grid point of the color separation table created at the setting and creating and the separation value of another grid point adjacent to the one grid point is a certain level or larger, perform replacing the separation value corresponding to the one grid point with the separation value with which the difference decreases after the setting and creating and before the smoothing.

4. The color separation table creating method according to claim 1,
wherein the smoothing and the changing are repeated until a predetermined condition is satisfied and the partial color component which is fixed and the other color component which is changed are switched at each changing.

5. The color separation table creating method according to claim 4,
wherein the predetermined condition is that a color shift amount at all grid points is within a predetermined value.

6. The color separation table creating method according to claim 1,
wherein, at the setting and creating, the separation value is determined such that a sum of color materials represented by the separation value is minimized at each grid point.

7. A non-transitory recording medium storing a computer readable program executed by an information processing device, the program comprising:
setting and creating;
smoothing; and
changing,
of the color separation table creating method according to claim 1.

8. A printing device comprising:
a conveyor which conveys a recording medium;
an image former which forms an image using a process color or the process color and a spot color on a recording medium conveyed by the conveyor;
a hardware processor which converts an input process color signal value into a separation value by using a color separation table created by the color separation table creating method according to claim 1; and
a selector which receives a selection between a basic mode for forming an image using only the process color and a spot color using mode for forming an image using the process color and the spot color,
wherein the hardware processor allows the image former to form an image by using only the process color in a case where the basic mode is selected by the selector, and allows the image former to form an image by using the process color and the spot color according to the separation value obtained by converting the input process color signal value by the signal value converter in a case where the spot color using mode is selected by the selector.
